(19) United States
(12) Patent Application Publication
(10) Pub. No.: US 2015/0295317 A1
(43) Pub. Date: Oct. 15, 2015

(54) ANTENNA DEVICE

(71) Applicant: Harada Industry Co., Ltd., Tokyo (JP)

(72) Inventors: Jun Ito, Tokyo (JP); Junichi Kawahata, Tokyo (JP)

(21) Appl. No.: 14/679,304

(22) Filed: Apr. 6, 2015

(30) Foreign Application Priority Data
Apr. 11, 2014 (JP) 2014-081513

(51) Int. Cl. H01Q 9/04

(52) U.S. Cl. CPC H01Q 9/0407

(57) ABSTRACT

An antenna device includes a first antenna element. The first antenna element includes a first conductive line portion extending from a power supply point, a first turn-back portion connected to the first conductive line portion, a second conductive line portion extending from the first turn-back portion, a second turn-back portion connected to the second conductive line portion, a third conductive line portion extending from the second turn-back portion, a first shortcircuit portion shortcircuiting the first conductive line portion and the second conductive line portion, the first shortcircuit portion being located between a reference portion and the first turn-back portion, the reference portion being located between the first turn-back portion and the second turn-back portion, and a second shortcircuit portion shortcircuiting the reference portion and the third conductive line portion.

### CROSS-REFERENCE TO RELATED APPLICATIONS

This application is based upon and claims the benefit of priority from the prior Japanese Patent Application No. 2014-081513, filed on Apr. 11, 2014, the entire contents of which are incorporated herein by reference.

### FIELD

The present invention relates to a compact antenna device capable of having a resonant frequency thereof adjusted.

### BACKGROUND

Recently, along with improvement in vehicle-mountable mediums, it has become necessary that vehicle-mountable antennas transmit and receive radio waves in a frequency band corresponding to each of mediums. Therefore, for a vehicle-mountable antenna, an antenna system selected from many various antenna systems is mounted. In addition, the range of frequency band usable by the vehicle-mountable antennas is now broadened. A communication device using AM/FM frequencies, among such a broad frequency range, is currently mounted on vehicles as a standard device and is used to receive music and sport broadcasts and also to acquire traffic and weather information. A communication device using the AM/FM frequencies is also used in a car navigation system, specifically, in a vehicle information and communication system (VICS), which is a communication system that informs drivers of latest traffic information such as information on traffic jams and the like. Such a communication device is one of the most basic devices needed for an enjoyable driving environment.

Recently, an antenna device mountable on a vehicle is desired to have a design that does not spoil the external appearance of the vehicle or a design that does not cause the user to be aware of the presence of the antenna. In such a situation, antenna devices built in vehicle parts such as a spoiler or the like have been developed. For example, Japanese Laid-Open Patent Publication No. 2011-035519 discloses an antenna device including an antenna, receiving AM/FM-band radio waves, built in a spoiler.

However, in the case where an antenna built in a spoiler as described in Japanese Laid-Open Patent Publication No. 2011-035519 is used, unlike in the case where a conventional antenna mounted on a roof of a vehicle such as, for example, a monopole antenna or a shark fin antenna is used, it is difficult to adjust the resonant frequency of the antenna after the antenna is mounted on the vehicle. In addition, the resonant frequency of a compact antenna built in a spoiler varies depending on the structure of the vehicle on which the antenna is mounted or the site where the antenna is located, even where the same antenna device is used. Therefore, the resonant frequency of such a compact antenna built in a spoiler needs to be adjusted in the exact vehicle on which the antenna is to be used.

For the above reason, the shape of the antenna needs to be designed for each of models of vehicles on which the antenna is to be mounted. The final shape of the antenna cannot be determined until a trial model of the vehicle on which the antenna is to be mounted is produced. In other words, as the structure of the vehicle on which the antenna is to be mounted or the site where the antenna is to be located is changed, the design of the antenna also needs to be changed. A delay in designing the antenna influences the time to start mass production of the antenna, which may possibly cause a problem of losing an opportunity or the like. As described above, the conventional antenna device built in a spoiler is not versatile regarding the vehicle on which the antenna device is to be mounted, and the shape of the antenna needs to be designed for each of models of vehicles on which the antenna is to be mounted. Therefore, the development time period and cost are increased, which increases production cost of the antenna.

### SUMMARY

An antenna device in an embodiment according to the present invention includes a first antenna element. The first antenna element includes a first conductive line portion extending from a power supply point, a first turn-back portion connected to the first conductive line portion, a second conductive line portion extending from the first turn-back portion, a second turn-back portion connected to the second conductive line portion, a third conductive line portion extending from the second turn-back portion, a first shortcircuit portion shortcircuiting the first conductive line portion and the second conductive line portion, the first shortcircuit portion being located between a reference portion and the first turn-back portion, the reference portion being located between the first turn-back portion and the second turn-back portion, and a second shortcircuit portion shortcircuiting the reference portion and the third conductive line portion.

An antenna device in an embodiment according to the present invention includes a first antenna element. The first antenna element includes a first conductive line portion extending from a power supply point, a first turn-back portion connected to the first conductive line portion, a second conductive line portion extending from the first turn-back portion, a second turn-back portion connected to the second conductive line portion, a third conductive line portion extending from the second turn-back portion, a wiring portion having a possibility of shortcircuiting the first conductive line portion and the second conductive line portion, the wiring portion having a gap and being located between a reference portion and the first turn-back portion, the reference portion being located between the first turn-back portion and the second turn-back portion, and a second shortcircuit portion shortcircuiting the reference portion and the third conductive line portion.

In another embodiment, the first antenna element further may include a third shortcircuit portion shortcircuiting the second conductive line portion and the third conductive line portion, the third shortcircuit portion being located between the reference portion and the second turn-back portion.

An antenna device in an embodiment according to the present invention a first antenna element. The first antenna element includes a first conductive line portion extending from a power supply point, a first turn-back portion connected to the first conductive line portion, a second conductive line portion extending from the first turn-back portion, a second turn-back portion connected to the second conductive line portion, a third conductive line portion extending from the second turn-back portion, a first shortcircuit portion shortcircuiting the first conductive line portion and the second conductive line portion, the first shortcircuit portion being located between a reference portion and the first turn-back portion, the reference portion being located between the first turn-back portion and the second turn-back portion, and a second shortcircuit portion shortcircuiting the second conductive portion and the third conductive line portion, the second shortcircuit portion being located between the reference portion and the second turn-back portion.

An antenna device includes a first antenna element. The first antenna element includes a first conductive line portion extending from a power supply point, a first turn-back portion connected to the first conductive line portion, a second conductive line portion extending from the first turn-back portion, a second turn-back portion connected to the second conductive line portion, a third conductive line portion extending from the second turn-back portion, a wiring portion having a possibility of shortcircuiting the first conductive line portion and the second conductive line portion, the wiring portion having a gap and being located between a reference portion and the first turn-back portion, the reference portion being located between the first turn-back portion and the second turn-back portion, and a second shortcircuit portion shortcircuiting the second conductive line portion and the third conductive line portion, the second shortcircuit portion being located between the reference portion and the second turn-back portion.

In still another embodiment, the antenna device may further include a second antenna element connected to the third conductive line portion.

In still another embodiment, the second antenna element may include a portion having a larger line width than that of the first antenna element.

### BRIEF DESCRIPTION OF DRAWINGS

FIG. 1 is a schematic view showing an example of structure of an antenna element of an antenna device in embodiment 1 according to the present invention;

FIG. 2 is a schematic view showing an example of structure of another antenna element of the antenna device in embodiment 1 according to the present invention;

FIG. 3 is a schematic view of the antenna element shown in FIG. 2, of the antenna device in embodiment 1 according to the present invention, in which a conductive member is located at one of gaps of wiring portions;

FIG. 4 is a schematic view showing an example of structure of still another antenna element of the antenna device in embodiment 1 according to the present invention;

FIG. 5 is a schematic view showing an example of structure of still another antenna element of the antenna device in embodiment 1 according to the present invention;

FIG. 6 shows a flowchart of a method for producing the antenna device in embodiment 1 according to the present invention and the shape of an antenna element of the antenna device in each of steps included in the method;

FIG. 7 is a schematic view showing an example of structure of an antenna element of an antenna device in a modification of embodiment 1 according to the present invention;

FIG. 8 is a schematic view showing an example of structure of an antenna device in embodiment 2 according to the present invention;

FIG. 9 is a schematic view showing a structure of another antenna device in embodiment 2 according to the present invention;

FIG. 10 is a schematic view showing a structure of still another antenna device in embodiment 2 according to the present invention;

FIG. 11 is a schematic view showing a structure of still another antenna device in embodiment 2 according to the present invention;

FIG. 12 is a schematic view showing a structure of an antenna device in embodiment 3 according to the present invention;

FIG. 13 is a schematic view showing an example of structure of an AM/FM receiving system in embodiment 4 according to the present invention;

FIG. 14 is a schematic view showing an example of structure of an antenna device in embodiment 5 according to the present invention; and

FIG. 15 is a schematic view showing an example of structure of an AM/FM receiving system in embodiment 5 according to the present invention.

### DESCRIPTION OF EMBODIMENTS

Hereinafter, an antenna device according to the present invention will be described with reference to the drawings. The antenna device according to the present invention may be carried out in many various forms, and is not to be construed as being limited to the following embodiments. In the drawings referred to in the following embodiments, the same components or the components having substantially the same functions will bear identical reference signs, and detailed descriptions thereof will not be repeated.

### Embodiment 1

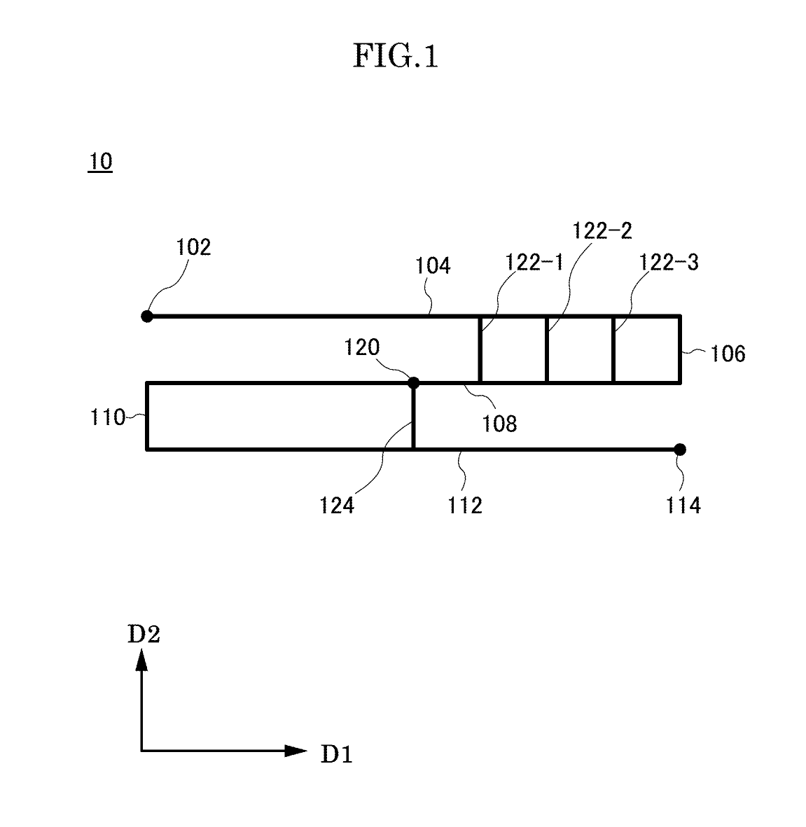

With reference to FIG. 1 through FIG. 6, a structure of an antenna device in embodiment 1 according to the present invention will be described. FIG. 1 is a schematic view showing an example of structure of an antenna element 10 of the antenna device in embodiment 1 according to the present invention.

### (Overview of the Antenna Device)

As shown in FIG. 1, the antenna element 10 of the antenna device includes a first conductive line portion 104 extending from a power supply point 102, a first turn-back portion 106 connected to the first conductive line portion 104, a second conductive line portion 108 extending from the first turn-back portion 106, a second turn-back portion 110 connected to the second conductive line portion 108, and a third conductive line portion 112 extending from the second turn-back portion 110. The antenna element 10 may be connected to a second antenna element at an end 114 of the third conductive line portion 112.

In the structure shown in FIG. 1, the first conductive line portion 104, the second conductive line portion 108 and the third conductive line portion 112 extend in a D1 direction. The antenna element 10 is not limited to having such a structure. For example, the above-described conductive line portions may extend in a direction crossing the D1 direction. The conductive line portions do not need to be parallel to each other. The conductive line portions do not need to be straight and may be curved.

The antenna element 10 further includes first shortcircuit portions 122 shortcircuiting the first conductive line portion 104 and the second conductive line portion 108. The first shortcircuit portions 122 are provided between a reference portion 120, located between the first turn-back portion 106 and the second turn-back portion 110, and the first turn-back portion 106. The first shortcircuit portions 122 include first shortcircuit portions 122-1, 122-2 and 122-3. In the case where not being specifically distinguished from each other, the first shortcircuit portions 122-1, 122-2 and 122-3 are each referred to as the “first shortcircuit portion 122”. The antenna element 10 also includes a second shortcircuit portion 124 shortcircuiting the reference portion 120 and the third conductive line portion 112. Herein, the second shortcircuit portion 124 will be also referred to as a “reference shortcircuit portion”.

In the structure shown in FIG. 1, the first shortcircuit portions 122 and the second shortcircuit portion 124 extend in a direction D2. The antenna element 10 is not limited to having such a structure. For example, the above-described shortcircuit portions may extend in a direction crossing the D2 direction. The shortcircuit portions do not need to be parallel to each other. The shortcircuit portions do not need to be straight and may be curved. The first shortcircuit portions 122 and the second shortcircuit portion 124 may be cut in accordance with a desired antenna length.

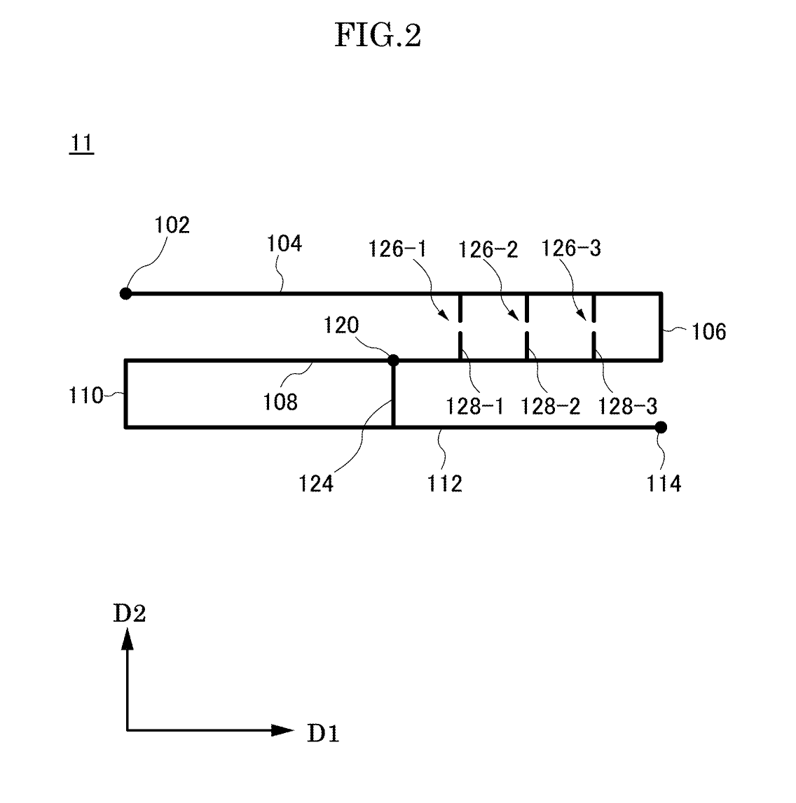

FIG. 2 is a schematic view showing an example of structure of another antenna element 11 of the antenna device in embodiment 1 according to the present invention. The antenna element 11 shown in FIG. 2 is similar to the antenna element 10 shown in FIG. 1, but is different from the antenna element 10 on the following point. The antenna element 11 shown in FIG. 2 includes wiring portions 128 having a possibility of shortcircuiting the first conductive line portion 104 and the second conductive line portion 108, instead of including the shortcircuit portions 122 provided in the antenna element 10. The wiring portions 128 have gaps 126. The gaps 126 include gaps 126-1, 126-2 and 126-3. In the case where not being specifically distinguished from each other, the gaps 126-1, 126-2 and 126-3 are each referred to as the “gap 126”. The wiring portions 128 include wiring portions 128-1, 128-2 and 128-3. In the case where not being specifically distinguished from each other, the wiring portions 128-1, 128-2 and 128-3 are each referred to as the “wiring portion 128”.

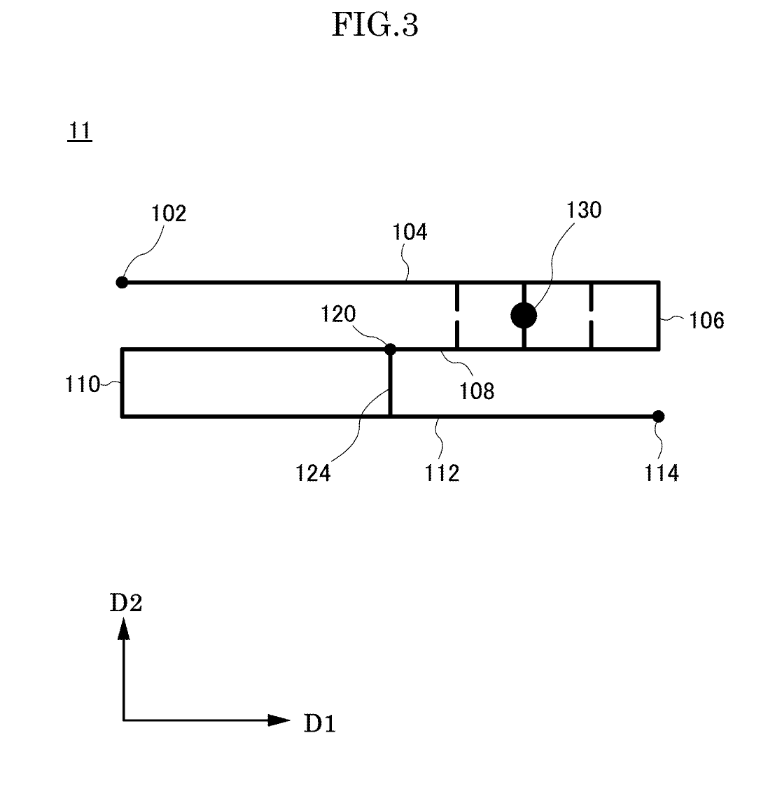

FIG. 3 is a schematic view of the antenna element 11 shown in FIG. 2, of the antenna device according to the present invention. FIG. 3 shows a state where a conductive member 130 is located at one of the gaps 126 of the wiring portions 128. Provision of the conductive member 130 at the gap 126 of the wiring portion 128 as shown in FIG. 3 allows the first conductive line portion 104 and the second conductive line portion 108 to be shortcircuited at a desired position.

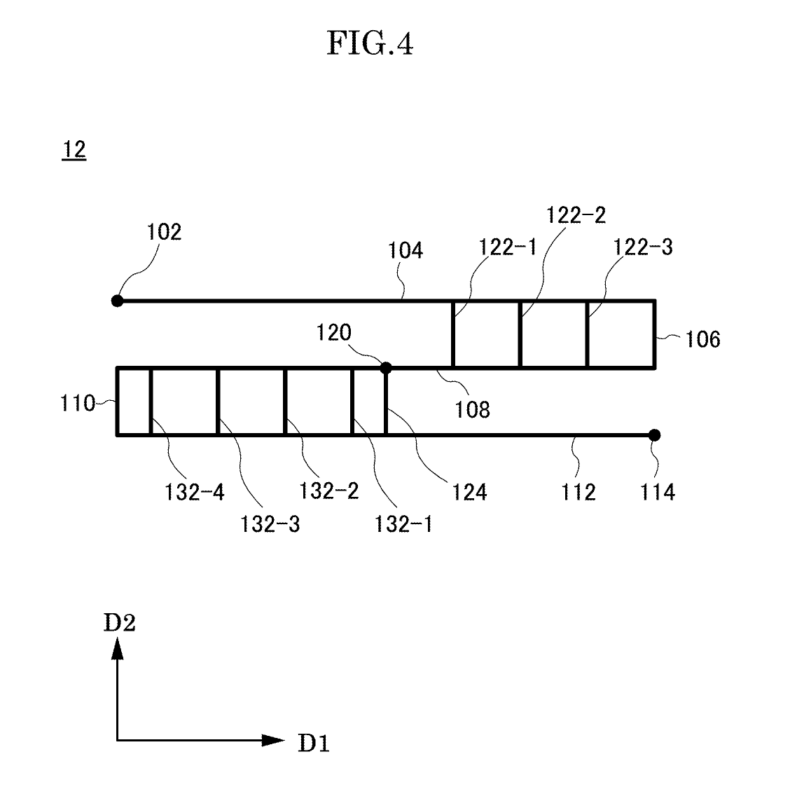

FIG. 4 is a schematic view showing an example of structure of still another antenna element 12 of the antenna device in embodiment 1 according to the present invention. The antenna element 12 shown in FIG. 4 is similar to the antenna element 10 shown in FIG. 1, but is different from the antenna element 10 on the following point. The antenna element 12 shown in FIG. 4 includes third shortcircuit portions 132 shortcircuiting the second conductive line portion 108 and the third conductive line portion 112, in addition to the first shortcircuit portions 122 also included in the antenna element 10. The third shortcircuit portions 132 are provided between the reference portion 120 and the second turn-back portion 110. The third shortcircuit portions 132 include third shortcircuit portions 132-1, 132-2, 132-3 and 132-4. In the case where not being specifically distinguished from each other, the third shortcircuit portions 132-1, 132-2, 132-3 and 132-4 are each referred to as the “third shortcircuit portion 132”. In the structure shown in FIG. 4, the third shortcircuit portions 132 are provided in addition to the components included in the antenna element 10 shown in FIG. 1. The antenna element 12 is not limited to having such a structure. For example, the third shortcircuit portions 132 may be provided in addition to the components included in the antenna element 11 shown in FIG. 2.

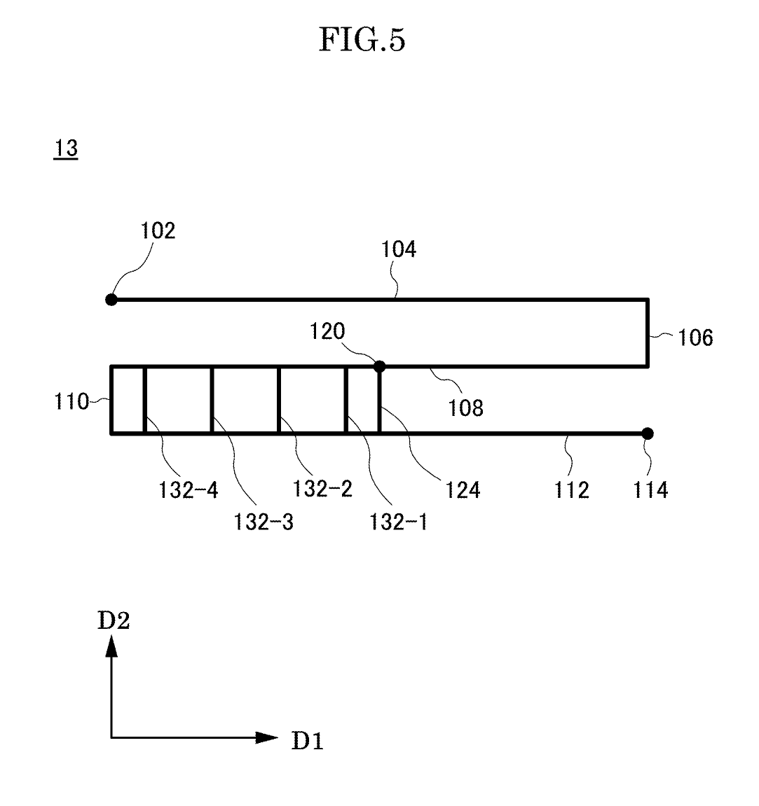

FIG. 5 is a schematic view showing an example of structure of still another antenna element 13 of the antenna device in embodiment 1 according to the present invention. The antenna element 13 shown in FIG. 5 is similar to the antenna element 12 shown in FIG. 4, but is different from the antenna element 12 on the following point. The antenna element 13 shown in FIG. 5 does not include the first shortcircuit portions 122.

### (Method for Producing an Antenna Device)

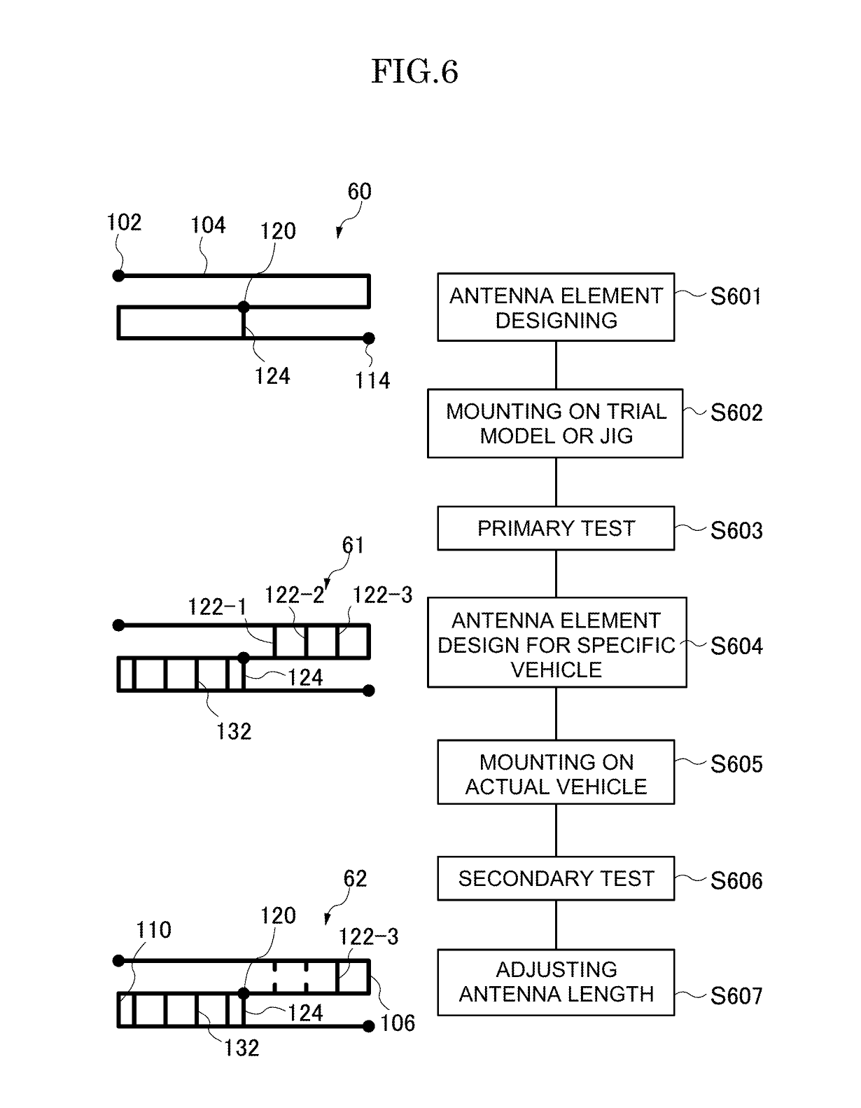

Now, with reference to FIG. 6, a method for producing the antenna device in embodiment 1 will be described. FIG. 6 shows a flowchart of the method for producing the antenna device and the shape of an antenna element included in the antenna device in each of steps included in the method. In FIG. 6, S601 through S607 are production steps of the method, and reference signs 60 through 62 each refers to an antenna element having a shape obtained in a corresponding step.

The method for producing the antenna device is roughly divided into two parts. A first part includes steps S601 through S604. In this part, the resonant frequency of the antenna element is adjusted (matched) to a band desired for a target vehicle on which the antenna device is to be mounted. In the case where, for example, the target vehicle is under development and the antenna device is to be developed in parallel with the vehicle, the first part corresponds to a stage before the completion of the target vehicle. A second part includes steps S605 through S607. In this part, the resonant frequency of the antenna element is fine-tuned after the antenna device is mounted on an actual vehicle. This part is performed in the case where the resonant frequency of the antenna element adjusted by the first part including steps S601 through S604 is shifted. The second part corresponds to a stage in which the resonant frequency of the antenna element is adjusted so as to be optimum to the actual vehicle on which the antenna device is mounted.

First, in the initial step of antenna element design (step S601), for the antenna device in embodiment 1, an antenna element 60 in an initial state is designed such that the resonant frequency thereof matches a band desired for the target vehicle, and the antenna element 60 is produced.

Next, the antenna element 60 designed and produced in step S601 is mounted on a trial model or a metal jig assumed to be the actual vehicle (step S602), and a primary test is performed on the antenna element 60 (step S603).

Next, based on the result of the primary test performed in S603, antenna element design for each of models of vehicles is performed (step S604). Specifically, this is performed as follows. First, an external surface area of the antenna element (also referred to as the “antenna pattern size” or “effective surface area”) is adjusted for AM-band radio waves, such that the receiving sensitivity of the antenna element for the AM-band radio waves is a desired value. Then, the antenna length of the antenna element is adjusted without changing the external surface area of the antenna element in order to adjust the receiving sensitivity for FM-band radio waves. More specifically, the shortcircuit portions 122 and 132 capable of adjusting the antenna length are added to the antenna element 60 in order to adjust the receiving sensitivity for the FM-band radio waves (see the antenna element 61). The shortcircuit portions 122 are located such that the antenna length of the antenna element 61 is shorter than the antenna length at which the receiving sensitivity for the FM-band radio waves is optimum. The external surface area of the antenna element may be adjusted by adjusting an external surface area of the second antenna element connected to the end 114 of the antenna element. The second antenna element will be described later in detail.

Next, the antenna element 61 designed and produced in step S604 is mounted on the actual vehicle (step S605), and a secondary test is performed on the antenna element 61 (step S606).

Next, based on the result of the secondary test, the antenna length is adjusted (step S607). Specifically, the first shortcircuit portions 122, the second shortcircuit portion 124 and the third shortcircuit portions 132 provided based on the design made in steps S601 and S604 are appropriately cut to adjust the antenna length. An antenna element 62 shown in FIG. 6 is an example of antenna element having the antenna length adjusted by cutting a part of the first shortcircuit portions 122. More specifically, the antenna element 62 is obtained by cutting the first shortcircuit portions 122-1 and 122-2, among the plurality of first shortcircuit portions 122 included in the antenna element 61.

The antenna length of the antenna element 62 is shorter than that of the antenna element 60 in the initial state because of the first shortcircuit portion 122-3. In other words, the first shortcircuit portions 122 located between the first turn-back portion 106 and the reference portion 120 is capable of decreasing the antenna length of the antenna element 60. The area where the first shortcircuit portions 122 are located is referred to as an “antenna length decreasing area”.

By contrast, an antenna element having a longer antenna length than that of the antenna element 60 can be produced by cutting the second shortcircuit portion 124 and the third shortcircuit portions 132 in the state where all the first shortcircuit portions 122 are cut. In other words, the third shortcircuit portions 132 located between the reference portion 120 and the second turn-back portion 110 are capable of increasing the antenna length of the antenna element 60. The area where the third shortcircuit portions 132 are located is referred to as an “antenna length increasing area”.

As described above, the second shortcircuit portion 124 is located at the border between the antenna length decreasing area and the antenna length increasing area, and is used as the reference for both of the areas. Thus, the second shortcircuit portion 124 may be referred to as a “shortcircuit reference portion”. In the above example, in step S604 of designing the antenna element for each of models of vehicles, an antenna element having substantially the same structure as that of the antenna element 12 shown in FIG. 4 is designed and produced. Alternatively, in step S604, an antenna element having substantially the same structure as that of the antenna element 10 shown in FIG. 1, the antenna element 11 shown in FIG. 2 or the antenna element 13 shown in FIG. 5 may be designed and produced, instead of the antenna element 12 shown in FIG. 4.

Embodiment 1 of the present invention described above provides a compact antenna device capable of having the resonant frequency thereof adjusted. Embodiment 1 according to the present invention also provides an antenna element capable of having both of the antenna length and the external surface area thereof adjusted. Embodiment 1 according to the present invention further provides an antenna element capable of having the antenna length in the initial state decreased or increased in a space-saving manner.

In order to adjust the receiving sensitivity of a conventional AM/FM-band antenna device for the AM-band radio waves, it is necessary to adjust the external surface area of the antenna element. In order to adjust the receiving sensitivity of a conventional AM/FM-band antenna device for the FM-band radio waves, it is necessary to adjust the antenna length of the antenna element. Unlike in the case of such an antenna element of the conventional antenna device, in the case of the antenna element in the antenna device according to the present invention, the external surface area is not changed even when the antenna length is adjusted after the antenna device is mounted on the vehicle. Therefore, both of the antenna length and the external surface area can be adjusted in a simple manner.

### Modification of Embodiment 1

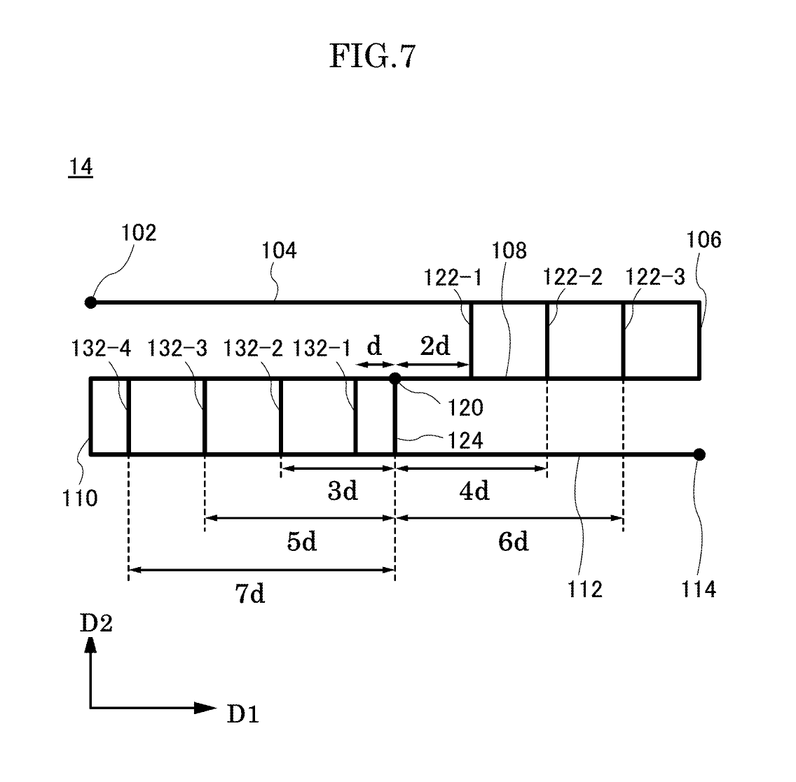

With reference to FIG. 7, a modification of embodiment 1 according to the present invention will be described. FIG. 7 is a schematic view showing an example of structure of an antenna element 14 of an antenna device in a modification of embodiment 1 according to the present invention. The antenna element 14 shown in FIG. 7 has a basic structure substantially the same as that of the antenna element 12 shown in FIG. 4. In the antenna length decreasing area of the antenna element 14, the first shortcircuit portions 122-1, 122-2 and 122-3 are located. In the antenna length increasing area of the antenna element 14, the third shortcircuit portions 132-1, 132-2, 132-3 and 132-4 are located. The antenna element 14 also include the second shortcircuit portion 124 shortcircuiting the reference portion 120 and the third conductive line portion 112.

The distances from the reference portion 120 to the first shortcircuit portions 122-1, 122-2 and 122-3 and the third shortcircuit portions 132-1, 132-2, 132-3 and 132-4 are different from one another. More specifically, each of the third shortcircuit portions 132 is located at a position away from the reference portion 120 by a distance expressed as “(2n−1)d (n is a natural number)”. Each of the first shortcircuit portions 122 is located at a position away from the reference portion 120 by a distance expressed as “(2n)d (n is a natural number)”.

In the antenna device in the modification of embodiment 1 described above, the distance from the reference portion 120 to each of the first shortcircuit portions 122 and the distance from the reference portion 120 to each of the third shortcircuit portions 132 are different from each other. Such a structure allows the antenna length to be adjusted more precisely. More specifically, the antenna length of the antenna element 14 can be adjusted more precisely by sequentially cutting the second shortcircuit portion 124, the third shortcircuit portion 132-1, the first shortcircuit portion 122-1, the third shortcircuit portion 132-2, and so on. The antenna element 14 is especially effective in the case where there is a limitation on the distance between adjacent shortcircuit portions.

### Embodiment 2

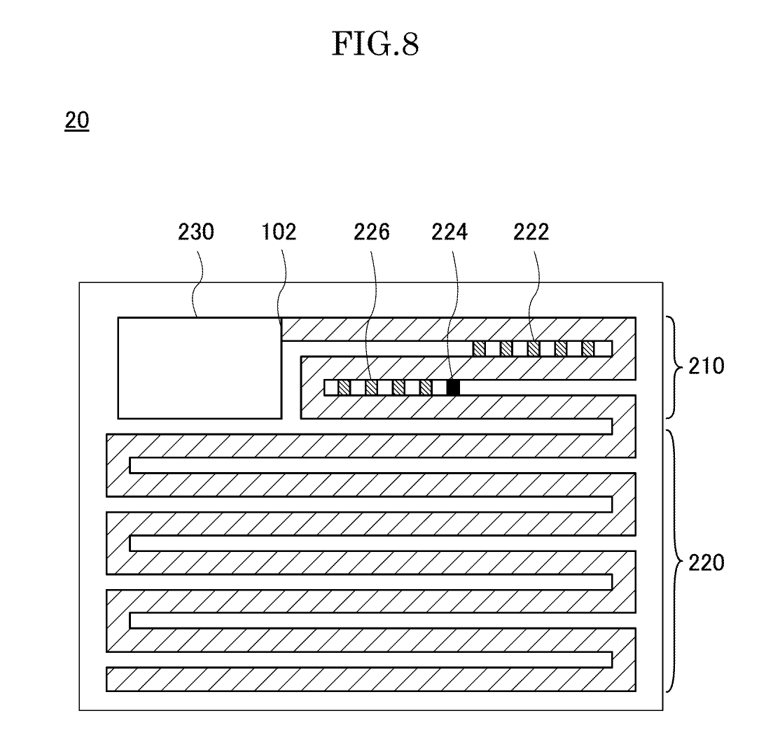

With reference to FIG. 8 through FIG. 11, a structure of an antenna device in embodiment 2 according to the present invention will be described. With reference to FIG. 8 through FIG. 11, various shapes usable for a second antenna element connected to the end 114 of the third conductive line portion 112 in each of the antenna elements described above with reference to FIG. 1 through FIG. 5 will be described in detail.

FIG. 8 is a schematic view showing an example of structure of an antenna device 20 in embodiment 2 according to the present invention. The antenna device 20 shown in FIG. 8 includes a first antenna element 210, a meandering second antenna element 220, and an amplification circuit 230. The first antenna element 210 is connected to the amplification circuit 230 at the power supply point 102, which is one end thereof, and is connected to the second antenna element 220 at the other end thereof. The first antenna element 210 includes a plurality of first shortcircuit portions 222 located in an antenna length decreasing area, a reference shortcircuit portion 224 located in a reference portion, and a plurality of third shortcircuit portions 226 located in an antenna length increasing area. The first antenna element 210 included in the antenna device 20 shown in FIG. 8 has substantially the same structure as that of the antenna element 12 shown in FIG. 4. The antenna device 20 is not limited to including such an antenna element, and may include an antenna element having another structure.

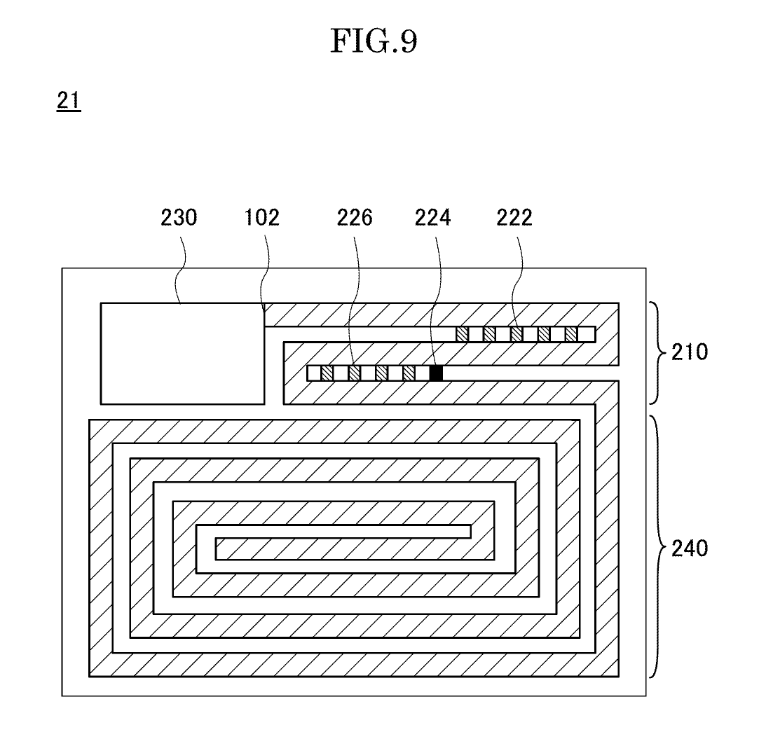

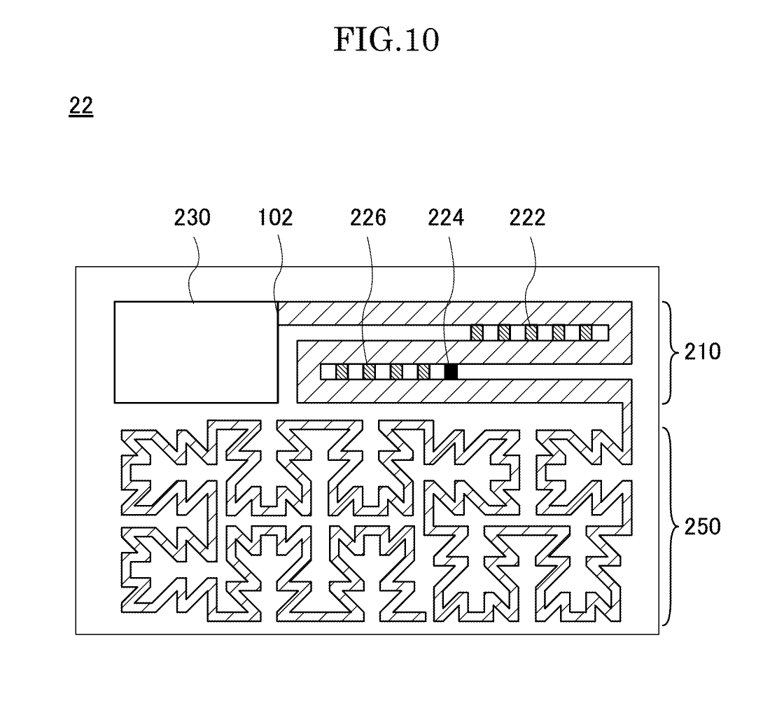

FIG. 9 and FIG. 10 are each a schematic view showing a structure of another antenna device in embodiment 2 according to the present invention. FIG. 9 shows an antenna device 21, which is similar to the antenna device 20 shown in FIG. 8 but is different from the antenna device 20 on the following point. The antenna device 21 includes a second antenna element 240 having a spiral shape. FIG. 10 shows an antenna device 22, which is similar to the antenna device 20 shown in FIG. 8 but is different from the antenna device 20 on the following point. The antenna device 22 includes a second antenna element 250 having a space-filling curve-like shape. The “space-filling curve” refers to a shape in which a space is filled with straight lines or curved lines. A so-called fractal pattern is one example of the space-filling curve. In FIG. 10, the shape of the second antenna element 250 is a combination of N-type patterns and inverted N-type patterns. The second antenna element 250 is not limited to having such a shape, and may have any of various other patterns.

In each of the antenna devices described above and shown in FIG. 8 through FIG. 10, the second antenna element has a long antenna length in a space of a certain size. Therefore, the antenna devices can be compact and still have a high receiving sensitivity for radio waves.

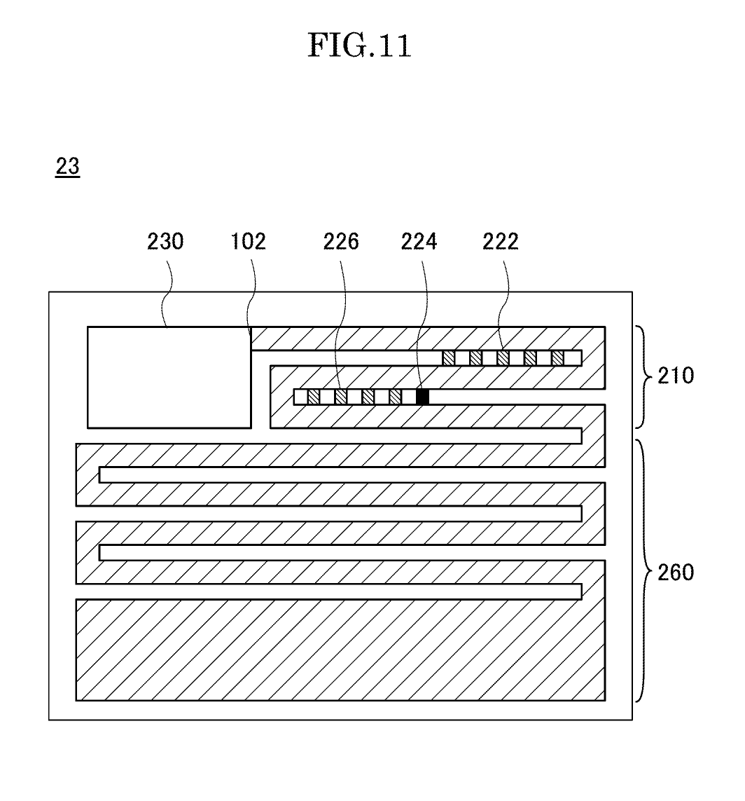

FIG. 11 is a schematic view showing an example of structure of still another antenna device 23 in embodiment 2 according to the present invention. The antenna device 23 shown in FIG. 11 is similar to the antenna device 20 shown in FIG. 8 but is different from the antenna device 20 on the following point. The antenna device 23 includes a second antenna element 260, which includes a portion having a larger line width than that of the first antenna element 210. More specifically, the line width of an end portion of the second antenna element 260 is larger than the line width of the remaining portion of the second antenna element 260 and also the first antenna element 210. In the antenna device 23 shown in FIG. 11, the end portion of the second antenna element 260 has a larger line width. The second antenna element 260 is not limited to having such a structure, and may have at least a portion having a larger line width.

The antenna device 23 described above and shown in FIG. 11 has a radio wave receiving area larger than that of another antenna device having the same antenna length, and thus has an improved receiving sensitivity for radio waves. This allows the antenna length to be decreased. Therefore, the antenna device 23 can be compact and still have a high receiving sensitivity for radio waves.

### Embodiment 3

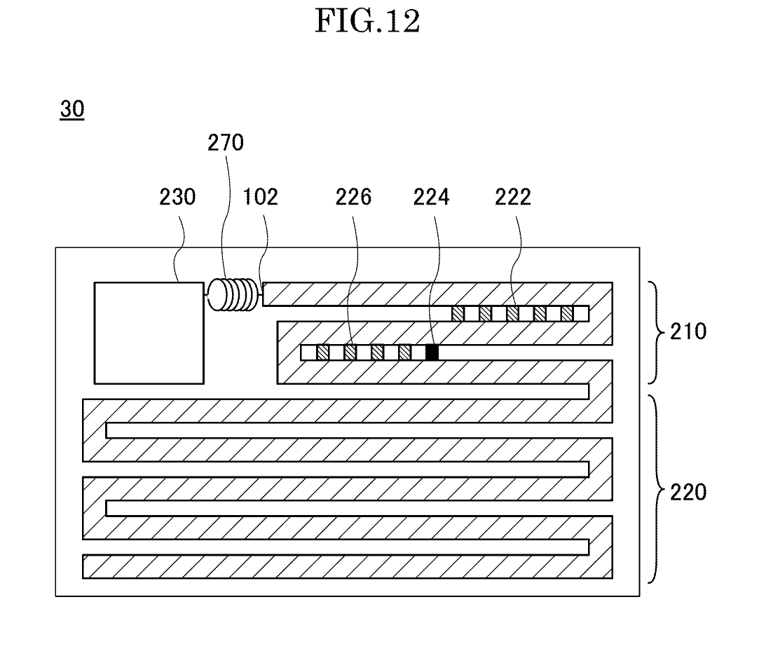

With reference to FIG. 12, a structure of an antenna device 30 in embodiment 3 according to the present invention will be described. The structure shown in FIG. 12 includes a coil 270 provided between the power supply point 102 for the first antenna element 210 and the amplification circuit 230.

FIG. 12 is a schematic view showing an example of structure of the antenna device 30 in embodiment 3 according to the present invention. The antenna device 30 is similar to the antenna device 20 shown in FIG. 8, but is different from the antenna device 20 on the following point. The antenna device 30 includes the coil 270 connected to the power supply point 102 for the first antenna element 210 and to the amplification circuit 230. The coil 270 may be in any form. For example, an external element having an L component of a coil may be used as the coil 270, or the coil 270 may be a generally planar spiral coil that is formed by use of top and bottom surfaces of a substrate on which the amplification circuit 230 is formed.

In antenna device 30 in embodiment 3 described above, the L component of the coil 270 located between the first antenna element 210 and the amplification circuit 230 allows the antenna length of each of the first antenna element 210 and the second antenna element 220 to be decreased. Therefore, the antenna device 30 can be more compact.

### Embodiment 4

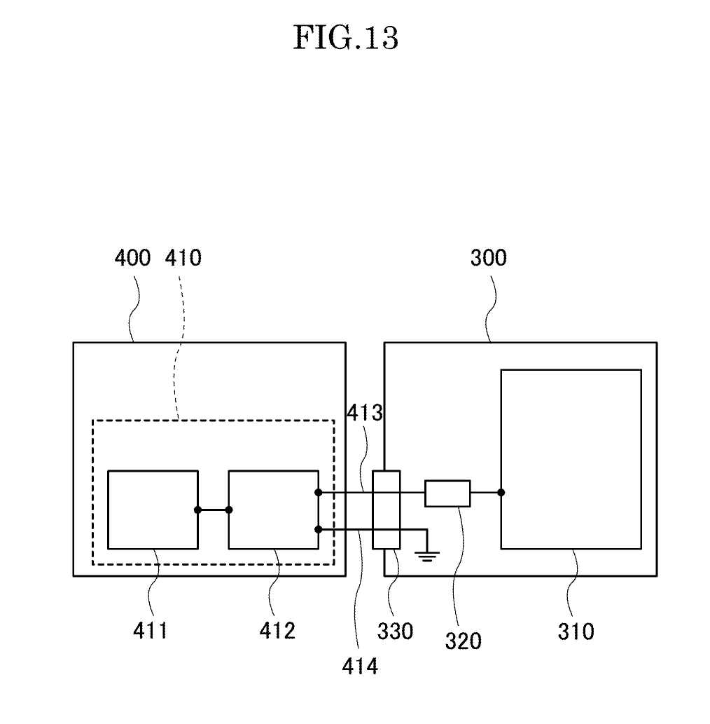

Now, with reference to FIG. 13, an AM/FM receiving system will be described. FIG. 13 is a schematic view showing an example of structure of an AM/FM receiving system in embodiment 4 according to the present invention. The AM/FM receiving system includes a spoiler antenna system 410 including an antenna element 411 and an amplification circuit 412. The spoiler antenna system 410 is located in a rear spoiler 400 of a vehicle. The AM/FM receiving system also includes a radio tuner 310 and a connecter 320, which are located inside a vehicle body 300. The amplification circuit 412 is connected to a power supply point of the antenna element 411. A signal line 413 and a ground wire 414 extend from the amplification circuit 412 and are introduced into an inner space of the vehicle body 300 via a through-hole (grommet) 330 for lines that is formed in the vehicle body 300. The signal line 413 is connected to the radio tuner 310 via the connector 320. The ground wire 414 is connected to a ground portion of the vehicle body 300. In the structure shown in FIG. 13, the antenna element 411 and the amplification circuit 412 are located in the rear spoiler 400.

### Embodiment 5

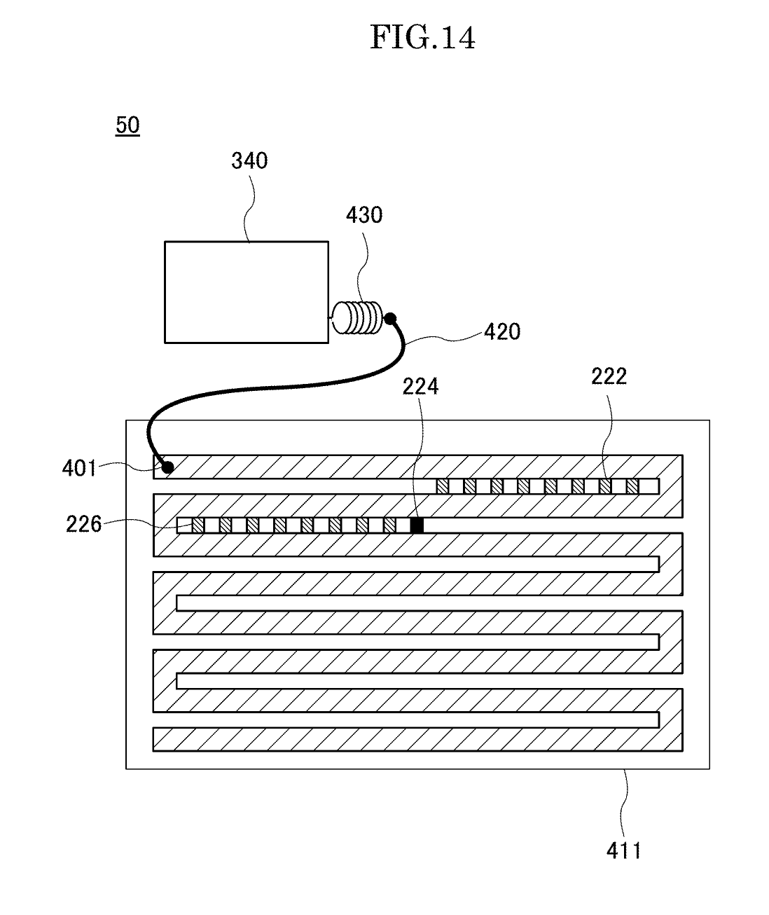

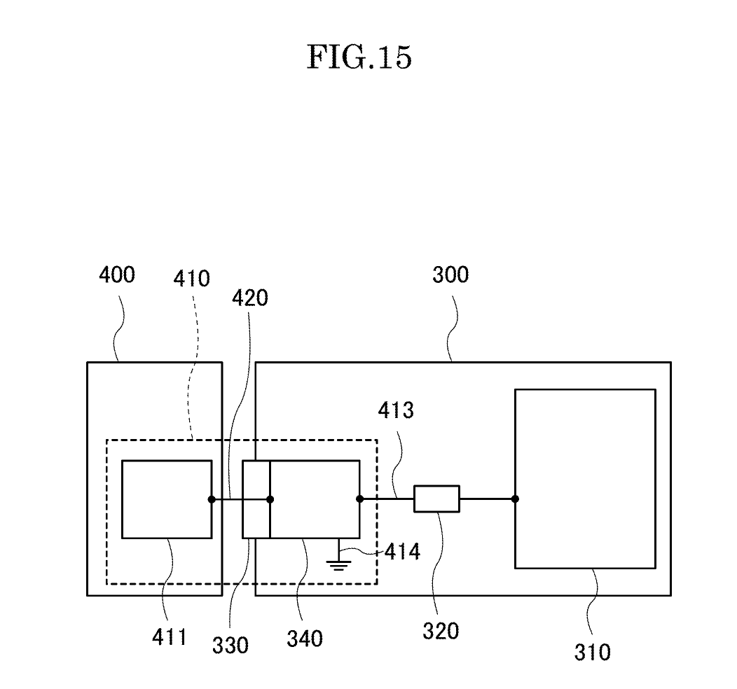

Now, with reference to FIG. 14 and FIG. 15, a structure of an antenna device 50 and an AM/FM receiving system in embodiment 5 according to the present invention will be described. FIG. 14 is a schematic view showing an example of structure of the antenna device 50 in embodiment 5 according to the present invention. FIG. 15 is a schematic view showing an example of structure of the AM/FM receiving system in embodiment 5 according to the present invention.

The antenna device 50 shown in FIG. 14 is similar to the antenna device 30 shown in FIG. 12, but is different from the antenna device 30 on the following point. The antenna device 50 includes a cable 420 provided between a power supply point 401 and an amplification circuit 340. In the structure shown in FIG. 14, the cable 420 is located between a coil 430 connected to an input portion of the amplification circuit 340 and the power supply point 401 of the antenna element 411. The antenna device 50 is not limited to having such a structure. For example, the coil 430 may be connected to the power supply point 401, and the cable 420 may be located between the coil 430 and the amplification circuit 340.

The AM/FM receiving system shown in FIG. 15 includes the antenna element 411 located in the rear spoiler 400 of a vehicle, and also includes the radio tuner 310, the connector 320 and the amplification circuit 340, which are located inside the vehicle body 300. The coil 430 also included in the antenna system 50 shown in FIG. 14 is located on the amplification circuit 340 although the coil 430 is not shown in FIG. 15. The cable 420 connecting the antenna element 411 and the amplification circuit 340 to each other is introduced into an inner space of the vehicle body 300 via the through-hole (grommet) 330 for lines that is formed in the vehicle body 300. The signal line 413 extending from the amplification circuit 340 is connected to the radio tuner 310 via the connector 320. The ground wire 414 extending from the amplification circuit 340 is connected to a grounding portion of the vehicle body 300.

As described above, the antenna device 50 in embodiment 5 allows the amplification circuit 340 to be located inside the vehicle body 300. This decreases the size of components located in the rear spoiler. Therefore, the antenna element can be located at a higher level of freedom with an enlarged design margin.

The present invention is not limited to the above embodiments, and may be appropriately altered without departing from the gist of the invention.

1. An antenna device, comprising:
a first antenna element, including:
a first conductive line portion extending from a power supply point;
a first turn-back portion connected to the first conductive line portion;
a second conductive line portion extending from the first turn-back portion;
a second turn-back portion connected to the second conductive line portion;
a third conductive line portion extending from the second turn-back portion;
a first shortcircuit portion shortcircuiting the first conductive line portion and the second conductive line portion, the first shortcircuit portion being located between a reference portion and the first turn-back portion, the reference portion being located between the first turn-back portion and the second turn-back portion; and
a second shortcircuit portion shortcircuiting the reference portion and the third conductive line portion.

2. An antenna device according to claim 1, wherein the first antenna element further includes a third shortcircuit portion shortcircuiting the second conductive line portion and the third conductive line portion, the third shortcircuit portion being located between the reference portion and the second turn-back portion.

3. An antenna device according to claim 1, further comprising a second antenna element connected to the third conductive line portion.

4. An antenna device according to claim 3, wherein the second antenna element includes a portion having a larger line width than that of the first antenna element.

5. An antenna device, comprising:
a first antenna element, including:
a first conductive line portion extending from a power supply point;
a first turn-back portion connected to the first conductive line portion;
a second conductive line portion extending from the first turn-back portion;
a second turn-back portion connected to the second conductive line portion;
a third conductive line portion extending from the second turn-back portion;
a wiring portion having a possibility of shortcircuiting the first conductive line portion and the second conductive line portion, the wiring portion having a gap and being located between a reference portion and the first turn-back portion, the reference portion being located between the first turn-back portion and the second turn-back portion; and
a second shortcircuit portion shortcircuiting the reference portion and the third conductive line portion.

6. An antenna device according to claim 5, wherein the first antenna element further includes a third shortcircuit portion shortcircuiting the second conductive line portion and the third conductive line portion, the third shortcircuit portion being located between the reference portion and the second turn-back portion.

7. An antenna device according to claim 5, further comprising a second antenna element connected to the third conductive line portion.

8. An antenna device according to claim 7, wherein the second antenna element includes a portion having a larger line width than that of the first antenna element.

9. An antenna device, comprising:
a first antenna element, including:
a first conductive line portion extending from a power supply point;
a first turn-back portion connected to the first conductive line portion;
a second conductive line portion extending from the first turn-back portion;
a second turn-back portion connected to the second conductive line portion;
a third conductive line portion extending from the second turn-back portion;
a first shortcircuit portion shortcircuiting the first conductive line portion and the second conductive line portion, the first shortcircuit portion being located between a reference portion and the first turn-back portion, the reference portion being located between the first turn-back portion and the second turn-back portion; and
a second shortcircuit portion shortcircuiting the second conductive portion and the third conductive line portion, the second shortcircuit portion being located between the reference portion and the second turn-back portion.

10. An antenna device according to claim 9, further comprising a second antenna element connected to the third conductive line portion.

11. An antenna device according to claim 10, wherein the second antenna element includes a portion having a larger line width than that of the first antenna element.

12. An antenna device, comprising:
a first antenna element, including:
a first conductive line portion extending from a power supply point;
a first turn-back portion connected to the first conductive line portion;
a second conductive line portion extending from the first turn-back portion;
a second turn-back portion connected to the second conductive line portion;
a third conductive line portion extending from the second turn-back portion;
a wiring portion having a possibility of shortcircuiting the first conductive line portion and the second conductive line portion, the wiring portion having a gap and being located between a reference portion and the first turn-back portion, the reference portion being located between the first turn-back portion and the second turn-back portion; and
a second shortcircuit portion shortcircuiting the second conductive line portion and the third conductive line portion, the second shortcircuit portion being located between the reference portion and the second turn-back portion.

13. An antenna device according to claim 12, further comprising a second antenna element connected to the third conductive line portion.

14. An antenna device according to claim 13, wherein the second antenna element includes a portion having a larger line width than that of the first antenna element.
